(19) United States
(12) Patent Application Publication
(10) Pub. No.: US 2010/0033625 A1
(43) Pub. Date: Feb. 11, 2010

(54) APPARATUS AND METHOD FOR MANAGING OUTPUT OF MEDIA INFORMATION

(76) Inventor: Eun Hae Choi, Gumi-si (KR)

Correspondence Address: KED & ASSOCIATES, LLP, P.O. Box 221200, Chantilly, VA, 20153-1200, US

(21) Appl. No.: 12/407,581

(22) Filed: Mar. 19, 2009

(30) Foreign Application Priority Data
Jul. 2, 2008 (KR) 10-2008-0063814

(51) Int. Cl. H04N 7/025; H04N 5/445; H04N 5/50

(52) U.S. Cl. 348/462; 348/563; 348/731; 348/E05.099; 348/E05.097; 348/E07.017

(57) ABSTRACT

A broadcast receiver and method of processing broadcast data therein are disclosed, by which an original audio of a broadcast program is controlled to be outputted according to user setup. The present invention includes receiving a broadcast signal including original audio identifier information for identifying an original audio, detecting the original audio identifier information from the received broadcast signal, and outputting audio data corresponding to the detected original audio identifier information as an original data.

### CROSS-REFERENCE TO RELATED APPLICATION

This application claims priority to Korean Patent Application No. 10-2008-0063814 filed on Jul. 2, 2008 in Korea, the disclosure of which is incorporated herein by reference.

### BACKGROUND

1. Field

One or more embodiments described herein relate to managing the output of media information.

2. Background

The The program and system information protocol (PSIP) is a protocol used for digital television broadcasts. This protocol provides program information through a scheme that involves parsing messages encoded, for example, using a MPEG-2 standard. Some of this information may relate to foreign language broadcasts. Using PSIP,

foreign language broadcasts can be received by digital televisions on an analog channel with stereo sound, also known as a digital audio or multi-sound.

When a foreign language program is broadcast on an analog channel in only one language, the digital audio (or multi-sound) feature of digital television channels may be used to allow viewers to listen to the program in many different languages. However, known methods for managing foreign language programs have drawbacks.

### BRIEF DESCRIPTION OF DRAWINGS

FIG. 1 is a diagram showing one embodiment of a program map table (PMT) syntax used in association with a broadcast receiver.

FIG. 2 is a diagram showing one embodiment of a virtual channel table (VCT) syntax used in association with a broadcast receiver.

FIG. 3 is a flow chart showing steps included in one embodiment of a method for processing broadcast data on a transmitting side of a broadcast system.

FIG. 4 is a diagram showing one embodiment of a broadcast receiver for receiving and processing PMT or VCT tables used in association with PSI/PSIP broadcast protocols.

FIG. 5 is a flow chart showing steps included in one embodiment of a method for processing audio in a broadcast receiver, which receives and processes PMT or VCT tables used in association with of PSI/PSIP broadcast protocols.

FIG. 6 is a diagram showing an example of an on-screen display (OSD) for selecting an output of original audio that may be used in accordance with one or more of the aforementioned embodiments.

FIG. 7 is a flow chart showing steps included in another embodiment of a method for processing audio in a broadcast receiver, which receives and processes PMT or VCT tables used in association with PSI/PSIP broadcast protocols.

FIG. 8 is a diagram showing an example of another OSD for selecting an output of original audio that may be used in accordance with one or more of the foregoing embodiments.

### DETAILED DESCRIPTION

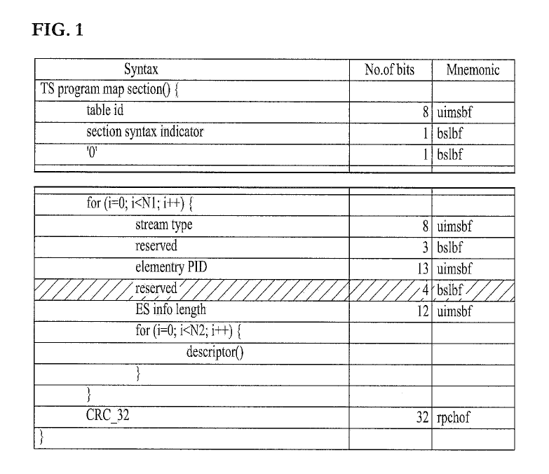

FIG. 1 shows one embodiment of a program map table (PMT) syntax. The program map table used in accordance with this embodiment may be a table that carries program information transmitted on at least one physical channel. In particular, the PMT may include information on a program broadcast on each of a plurality of channels. This program information may include, for example, audio_pid video_pid, teletext_pid, and pcr_pid as well as other information. A broadcast receiver is able to configure a table using this information.

Transmission of a basic PMT may be explained as follows. This initially involves transmitting a program association table (PAT) with a ‘packet ID’ defined as ‘0x00.’ The PAT is able to receive the PMT by parsing the ‘packet ID’ for carrying the PMT.

The PMT also includes or is otherwise associated with a plurality of reserved fields exist. According to one embodiment, a reserved field located next to an ‘elementary PID’ field is defined as an original audio identification field. For instance, referring to FIG. 1, in the case where four bits are allocated to a reserved field, 1 bit may be used to identify original audio. Language information of original audio may be set to the 1 bit of the reserved field and transmitted from a transmitting side of a broadcast system.

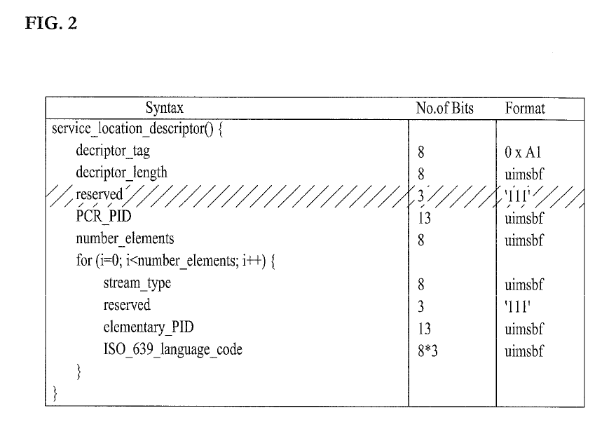

FIG. 2 shows one embodiment of a virtual channel table syntax. The VCT used in accordance with this embodiment may be a table that carries program information transmitted on the at least one physical channel. The VCT may be divided into a predetermined number (e.g., 256) of sections, each section carrying channel information for several virtual channels. Information on a single virtual channel is not divided into at least two sections.

The bitstream syntax of a terrestrial VCT may include a transport stream ID, channel number (major_channel_number, minor_channel_number), short_name, and carrier_frequency, program_number as well as other information, and side information may be included in a VCT descriptor. The program_number may be used to connect a virtual channel where MPEG-2 PAT (program association table) and PMT (program map table) tables are defined, and may be used to match a program number within the PAT/PMT.

The PAT describes a program identification number, a PID list of a transport packet carrying individual bit sequences of video, audio and the like for configuring a program, as well as annex information. Unlike the PMT table, information of all virtual channels existing within each physical channel is transmitted via a single VCT.

Meanwhile, if information on an original audio of a currently broadcasted broadcast program is defined within a VCT that carried program information in a manner similar to that of the aforesaid PMT, output of the original audio is able to be efficiently performed. A plurality of unused reserved fields exist within the VCT. According to one embodiment, a reserved field located next to a ‘stream type’ field may be used as an original audio identification field.

As shown in FIG. 2, if three bits are allocated to this reserved field, 1 bit may be used as an identifier for identifying original audio. For instance, 1 bit of the reserved field may be set to language information based on information of the original audio and then may be transmitted from a transmitting side of the broadcast system.

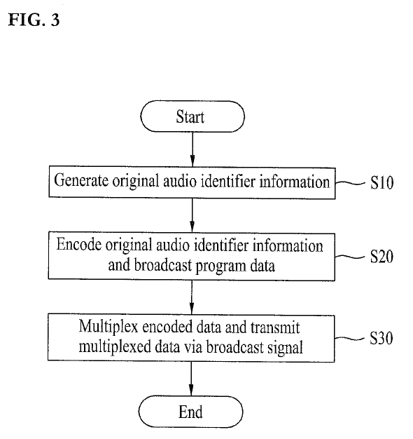

FIG. 3 is a flow chart showing steps included in one embodiment of a method for processing broadcast data on a transmitting side of a broadcast system. According to this method, the transmitting side generates identification information for identifying original audio of a program. This information is included or otherwise represented in a reserved field within a PMT or VCT (S10). Next, the original audio identification information and broadcast program data are encoded by MPEG-2 compression scheme (S20). The encoded data is multiplexed into a broadcast signal which is transmitted to a broadcast receiver (S30).

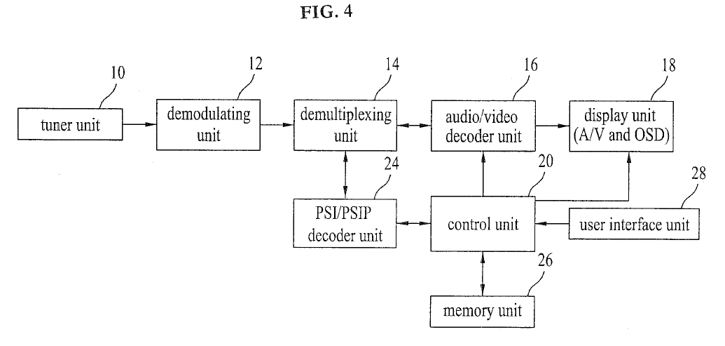

FIG. 4 shows an embodiment of a broadcast receiver that receives and processes a PMT or VCT based on PSI/PSIP protocols. The receiver includes a tuner unit 10, a demodulating unit 12, a demultiplexing unit 14, an audio/video decoder unit 16, a display unit (A/V and OSD) 18, a PSI/PSIP decoder unit 24, a control unit 20, a user interface unit 28, and a memory unit 26.

The broadcast receiver is coupled to or may be incorporated within a digital television (DT) capable, for example, of digital broadcast reception. The tuner unit 10 receives a digital broadcast signal including a PSI/PSIP table. The PMT (program map table) and VCT (virtual channel table) previously described may be included in the PSI/PSIP table.

The demodulating unit 12 demodulates a signal received from the tuner unit into a VSB/EVSB (vestigial sideband/enhanced vestigial sideband) signal.

The demultiplexing unit 14 demultiplexes the signal demodulated by the demodulating unit into audio data, video data and PSI/PSIP table data. The demultiplexing for the audio data and video data is controlled by control unit 20, while demultiplexing for the PSI/PSIP table data is controlled by PSI/PSIP decoder unit 24. The demultiplexed PSI/PSIP table is transmitted to the PSI/PSIP decoder unit, while the demultiplexed audio and video data are transmitted to audio/video decoder unit 16. The audio-video decoder decodes the received data, and the PSI/PSIP decoder 24 parses PSI/PSIP section.

The control unit 20 detects original audio identification information from the broadcast signal received by the tuner unit, and then controls the audio data of the broadcast signal to be output as original audio via display unit 180 in correspondence with the detected identification information. The original audio identification information is detected from a reserved field of a table within PSI and PSIP of the broadcast signal, and information on the original audio is defined by 1 bit in the reserved field.

The user interface unit 28 selectively receives output of audio corresponding to a video signal from a user via an audio select menu OSD window. This information is then sent to the control unit.

If a user selects output of the original audio, the user interface unit 28 allows the user to select whether to output the original audio for or in all languages or the original audio for or in only one or more user-specific languages. The user interface unit 28 receives and transmits the information on the input original audio output language to the control unit.

For example, if the user attempts to listen to audio data of or in all languages, the user may select an ‘all languages’ setting to output audio data in the original language. If the user attempts to listen to audio data of or in ‘English, Italian, Korean’ via original languages (original audio) only, the user is able to select ‘English, Italian, Korean’ to be outputted as original languages.

The memory unit 26 stores language information on the original audio output selected by the user. Accordingly, if the user sets the output of the original audio to all languages or the original audio of the received broadcast signal is identical to the user-selected language stored in the memory unit 26, the control unit controls output of the original audio according to the broadcast signal.

For example, when the audio data indicated by the original audio identification information included in a broadcast signal is ‘Arabic,’ then if the user sets the original audio output to be all languages or if the user selects ‘Arabic’, control unit 20 outputs the audio data based on the original audio identification information.

In particular, according to the present invention, the broadcast receiver identifies original audio from a plurality of audio data. Then, a determination is made as to whether the identified original audio corresponds to the language set in the broadcast receiver. If the identified original audio corresponds to the set language, the original audio is outputted. Therefore, the present embodiment is able to output original audio data corresponding to a language (e.g., all languages, several kinds of languages, etc.) selected by a user while identifying an original audio from audio data included in a broadcast signal.

If the original audio is not included in the audio output language set up by the user, the control unit controls output of the original audio as the language which is set to a default by the user or a manufacturer of the product. In the above example, when the original audio identified from the broadcast signal is ‘Arabic’, if it fails to correspond to one or more of the user-selected languages, the control unit controls output of the audio data in ‘English’ which corresponds to the default setting. The audio data may be output audibly the language corresponding to the default setting and/or text (e.g. subtitles corresponding to the language of the default setting) may be displayed on the screen.

The demultiplexing unit then demultiplexes the PMT, VCT tables as well as other information and transmits the demultiplexed PMT, VCT to the PSI/PSIP decoder 24.

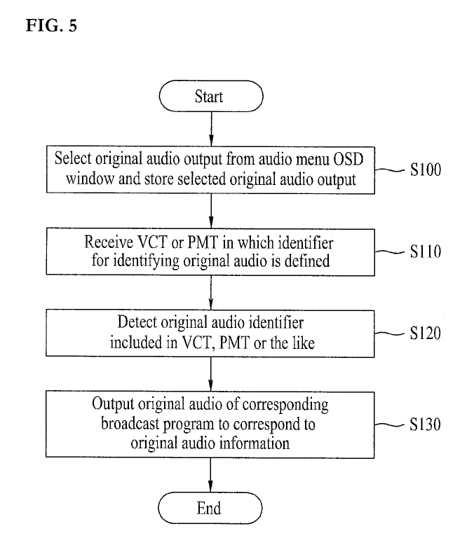

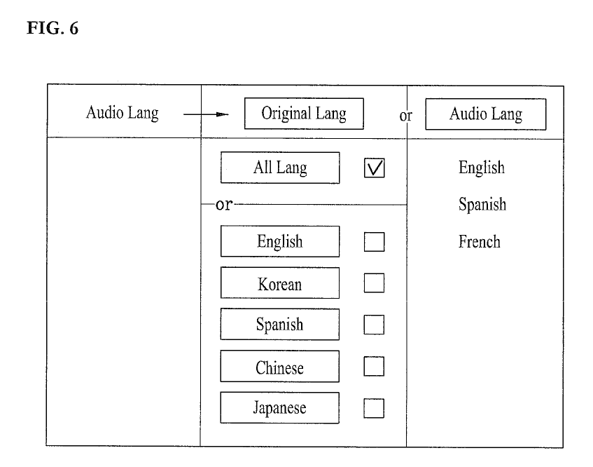

FIG. 5 is a flow chart showing steps included in another embodiment of a method for processing audio in a broadcast receiver, which receives and processes PMT or VCT tables based on PSI/PSIP protocols. Initially, when a user selects audio output corresponding to ‘original,” using an audio output selection OSD provided by a broadcast receiver, control unit 20 stores audio output information in memory unit 26 (S100). This operation may be explained in greater detail with reference to FIG. 6.

FIG. 6 shows an on-screen display (OSD) for selecting output of original audio. Using a local key provided, for example, in a main body of a broadcast receiver, a remote controller or the like, a user sets an original output of audio by selecting ‘Original Audio’ from an audio output selection menu OSD window.

When an original audio control menu is displayed, if the user desires to set all languages as original irrespective of the list of languages on the menu, the user selects ‘All Lang’ from an original audio output window. The control unit then stores information corresponding to the selected audio output information setting.

On the other hand, if the user desires to have a normal audio output, the user selects ‘Audio Lang’ from the audio selection menu OSD window and then checks to select a translatable language from a language selection window provided as a submenu.

In case that normal audio output is selected, audio is output in accordance with the language checked by the user irrespective of original audio information.

Returning to FIG. 5, subsequently, VCT or PMT tables, one or more of which include information for defining an identifier identifying an original audio of a broadcast program, is received from a broadcast transmitter (S110). The control unit of the broadcast receiver detects the identification information on the original audio from the reserved field of the PMT or VCT received via tuner unit 10 (S120). If the identifier information on the original audio is detected, audio of the corresponding broadcast program is output as original to correspond to the detected original audio information (S130).

For instance, if the original audio information (which is defined as Korean in the reserved field according to a broadcast signal of a currently received broadcast program) is received, the control unit checks that the original audio information according to the corresponding broadcast program is Korean and also checks whether the corresponding language (i.e., Korean) is set in memory unit 26, to be provided by being outputted as an original audio. If the user set the original output language as ‘All Lang,’ the control unit provides the audio of the corresponding broadcast program in Korean.

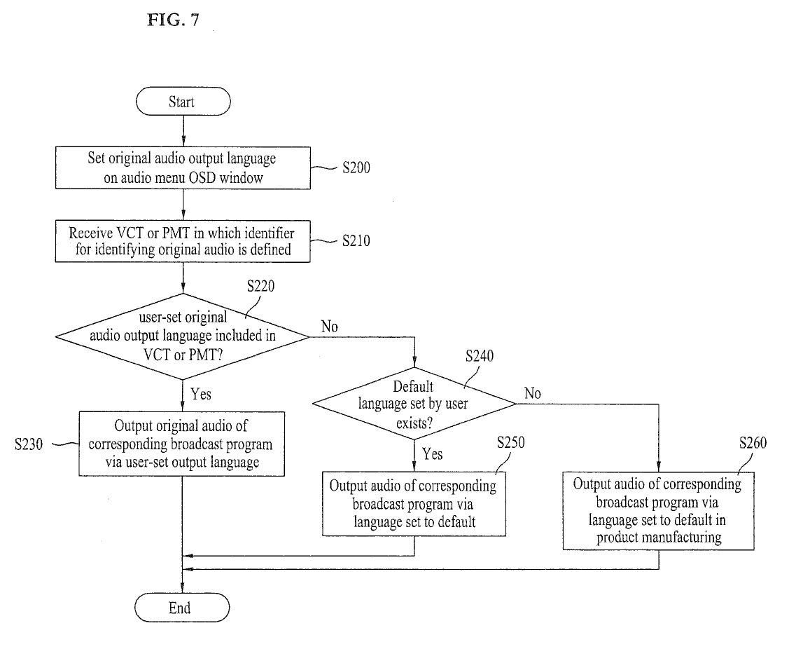

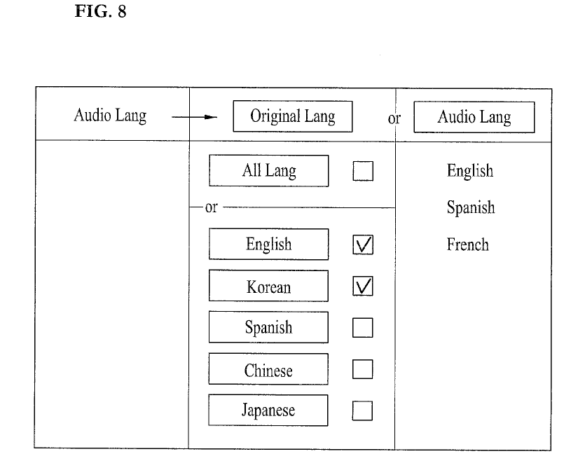

FIG. 7 is a flow chart showing steps included in an embodiment of a method for processing audio in a broadcast receiver, which receives and processes PMT or VCT tables of PSI/PSIP protocols. Initially, if a user selects ‘original’ as an audio output from an audio output selection OSD window provided by the broadcast receiver, control unit 20 stores audio output information in the memory unit 26 (S200). This process may be explained in greater detail with reference to FIG. 8.

FIG. 8 shows another type of on-screen display (OSD) for allowing a user to select an output of original audio. Using a local key provided, for example, on a main body of the broadcast receiver, a remote controller or the like, a user sets an original audio language output by selecting ‘Original Audio’ from an audio output selection menu OSD window. If the user wants to set the original audio output to one or more specific translatable languages, the user then selects the one or more languages provided in a submenu from an original audio output window. For instance, if the user selects two languages, English and Korean, as original output languages, control unit 20 stores the selected audio output information in the memory unit 26.

Subsequently, VCT and/or PMT tables, at least one of which includes identification information for identifying the original audio of a broadcast program, is received from a broadcast transmitter (S210). The control unit of the broadcast receiver then detects identification information on the original audio from the reserved field of the PMT or VCT received via tuner unit 10.

The control unit then compares the detected original audio identification information to the original audio output information stored in the memory unit. In particular, the control unit checks whether the original audio output language set up by the user is included in the broadcast signal (S220). As a result of the check, if the original audio output language set up by the user is included in the broadcast signal, the control unit outputs the original audio of the corresponding broadcast program in the language set up by the user (S230).

For example, if the audio output information set by the user corresponds to the languages English and Korean and English is detected from the broadcast signal, then the control unit will cause the audio of the corresponding broadcast program to be output in English as the original audio.

On the other hand, if the original audio output language set by the user is not included in the received broadcast signal in the step S220 (i.e., if the audio output information according to the detected original audio identification information is different from the user-set original output language), control unit 20 checks whether a preset default language exists (S240). As a result of the check, if the default language preset by the user exists, audio of the corresponding broadcast program is outputted in the default set language (S250).

If the user has not preset a default language in step S240, then the control unit outputs audio of the corresponding broadcast program in the default language set by the product manufacturer, e.g., the broadcast receiver manufacturer, television manufacturer, or the manufacturer of other equipment used in association with output of the program [S260].

For instance, if original audio information defines Spanish in a reserved field according to a broadcast signal of a currently received broadcast program, the control unit checks that the original audio information according to the corresponding broadcast program is Spanish and also checks whether the corresponding language, Spanish, is set in the memory unit 26 to be provided by being outputted as an original audio.

If the original audio information, which was set by a user and stored in memory unit 26, is English and Korean, the control unit detects the default set language information and then outputs the audio of the corresponding broadcast program in the default language.

In accordance with one or more of the foregoing embodiments, the audio data corresponding to a received video signal may be output audibly the language corresponding to the setting (e.g., ‘All Lang,” or one or more specific language, or a default language) and/or text (e.g. subtitles corresponding to the language of the setting) may be displayed on the screen. The text corresponding to the subtitles may be sent with the same broadcast signal as the audio or video signal, or in a different channel, transport stream, or signal.

Moreover, the specific languages shown in FIG. 6 may correspond to preferences set by a user. The preferences may be set, for example, by accessing a drop-down menu or control screen providing a comprehensive list of a larger number of languages. Also, in accordance with one or more of the foregoing embodiments, if the ‘All Lang’ setting is selected, then the audio signal/data may be output in the original language that was originally transmitted by the broadcaster.

Thus, in accordance with one or more of the foregoing embodiments, a broadcast receiver preferentially outputs an original language and enables a user to select a plurality of original languages. In particular, when audio of a broadcast program is output, a user is allowed to select a type of an output language while the original language is preferentially output. Therefore, the embodiments described herein will therefore be able to meet the various demands of users.

One or more embodiments further relate to a broadcast receiver and method of processing broadcast data which identify original audio of a received broadcast based on information contained within a table associated with PSI/PSIP protocols.

One or more embodiments further relate do a broadcast receiver and method of processing broadcast data which output original audio of a broadcast program with a high priority if a user has preset the original audio to a basic or default value.

In accordance with one embodiment, a method of processing broadcast data includes the steps of receiving a broadcast signal including original audio identifier information for identifying an original audio, detecting the original audio identifier information from the received broadcast signal, and outputting audio data corresponding to the detected original audio identifier information as an original data.

In accordance with another embodiment, a broadcast receiver includes a tuner unit receiving a broadcast signal including original audio identifier information for identifying an original audio, a memory unit storing original audio output information selected by a user, and a control unit detecting original audio identifier information from the broadcast signal received by the tuner unit, the control unit controlling audio data corresponding to the original audio identifier information to be outputted if the detected original audio identifier information is included in the audio output information stored in the memory unit.

In accordance with another embodiment, a method of processing data in a broadcast receiver includes the steps of generating original audio identifier information for identifying an original audio from a plurality of audio data, encoding the generated original audio identifier information and broadcast program data, and generating a broadcast signal by multiplexing the encoded data and transmitting the broadcast signal to the broadcast receiver.

The foregoing embodiments may achieve one or more of the following advantages. First, by allowing a user to set original audio to a basic or default value, the user's satisfaction is able to be optimized. This may be achieved based on including identification information in a PSI/PSIP table that identifies the original audio language of the corresponding broadcast program. Also, original audio data may be output corresponding to a user-selected language (all languages or several kinds of languages) while identifying an original audio among audio data included in a broadcast signal.

Moreover, a broadcast receiver is provided which preferentially outputs an original language of a broadcast program in one of a plurality of original languages selected by a user. Therefore, when the audio of a broadcast program is output, it will be output in the language selected by the user.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A method for managing output of media information, comprising:
detecting original audio identification information from a received program signal; and
outputting audio data in a language that corresponds to the original audio identification information.

2. The method of claim 1, further comprising:
storing original audio output information selected by a user,
wherein, if the original audio identifier information corresponds to the stored audio output information, the audio data is output in the language that corresponds to the original audio identification information.

3. The method of claim 1, wherein the original audio identification information is detected from a reserved field of a table of at least one of a program specific information (PSI) or program and system information protocol (PSIP) protocol.

4. The method of claim 3, wherein a prescribed bit of the reserved field is defined as the original audio identifier information.

5. The method of claim 2, wherein the original audio output information selected by the user includes a plurality of languages.

6. The method of claim 2, wherein the original audio output information selected by the user includes a plurality of languages and wherein if audio data corresponding to the detected original audio identifier information is included in the plurality of the languages, the audio data corresponding to the detected original audio identifier information is output as original audio.

7. The method of claim 6, further comprising:
if the audio data corresponding to the detected original audio identifier information is not included in a plurality of the languages, outputting the audio data in a default language.

8. A broadcast receiver comprising:
a tuner to receive a broadcast signal that includes original audio identification information;
a memory to store selected original audio output information; and
a controller to detect the original audio identification information from the broadcast signal received by the tuner, wherein the controller controls output of audio data in a language that corresponds the original audio identification information if the detected original audio identifier information is included in the audio output information stored in the memory.

9. The broadcast receiver of claim 8, wherein the controller detects the original audio identifier information from a reserved field of a table of at least one of a program specific information (PSI) or a program and system information protocol (PSIP) protocol.

10. The broadcast receiver of claim 9, wherein a prescribed bit of the reserved field is defined as the original audio identifier information.

11. The broadcast receiver of claim 8, wherein if the user sets an output of original audio for a plurality of languages, the controller controls the audio data to be output in a language corresponding to the original audio identifier information.

12. The broadcast receiver of claim 8, wherein the original audio output information selected by the user includes a plurality of languages and wherein if the language of audio data corresponding to the detected original audio identifier information is included in a plurality of the languages, the controller controls the audio data to be output in the language corresponding to the detected original audio identification information.

13. The broadcast receiver of claim 12, wherein if the language of the audio data corresponding to the detected original audio identifier information is not included in a plurality of the languages, the controller controls the audio data to be output in a language that corresponds to a default language.

14. A method of managing output of media information, comprising:
generating original audio identifier information for identifying an original audio from a plurality of audio data;
encoding the generated original audio identifier information and broadcast program data; and
generating a broadcast signal by multiplexing the encoded data and transmitting the broadcast signal to the broadcast receiver.

15. The method of claim 14, wherein the step of encoding the generated original audio identifier information and the broadcast program data comprises the step of encoding the generated original audio identifier information with the broadcast program data by including the original audio identifier information in a reserved field of a table within PSI (program specific information) and PSIP (program and system information protocol).

16. The method of claim 15, wherein the broadcast receiver defines the original audio identifier information in a prescribed bit of the reserved field.

17. The method of claim 14, wherein the broadcast receiver receives the broadcast signal, detects the original audio identifier information from the received broadcast signal, and outputs audio data corresponding to the detected original audio identifier information as an original audio.

18. The method of claim 17, wherein the broadcast receiver stores original audio output information selected by a user and wherein if the detected original audio identifier information is included in audio output information stored in a memory, the broadcast receiver outputs the audio data corresponding to the original audio identifier information as the original audio.

19. The method of claim 18, wherein the original audio output information selected by the user includes all kinds of languages.

20. The method of claim 18, wherein the original audio output information selected by the user includes a plurality of languages and wherein if the audio data corresponding to the detected original audio identifier information is included in a plurality of the languages, the broadcast receiver outputs the audio data corresponding to the detected original audio identifier information as the original audio.

21. The method of claim 20, wherein if the audio data corresponding to the detected original audio identifier information is not included in a plurality of the languages, the broadcast receiver outputs the audio data corresponding to the language set to a default.
